(19) United States
(12) Patent Application Publication
(10) Pub. No.: US 2020/0269411 A1
(43) Pub. Date: Aug. 27, 2020

(54) CONNECTION SYSTEM FOR A CLEANING DEVICE

(71) Applicant: Bradshaw International, Inc., Hudson, MA (US)

(72) Inventors: Robert Cavalcanti, Marlborough, MA (US); Kirk Morris, Cambridge, MA (US); Kathleen Calderini, Marlborough, MA (US)

(21) Appl. No.: 16/801,995

(22) Filed: Feb. 26, 2020

Related U.S. Application Data
(60) Provisional application No. 62/811,089, filed on Feb. 27, 2019.

(51) Int. Cl. B25G 3/26; B25G 3/38

(52) U.S. Cl. CPC B25G 3/26; B25G 3/38

(57) ABSTRACT

An connection system for removably attaching a cleaning accessory to a handle comprises a handle having a socket and a cleaning element having a connector, wherein different corresponding elements on the socket and connector allow for different ranges of motion between the cleaning element and the handle. The socket is defined by a base and a wall extending from the circumference of the base, the wall defining an interior chamber with an opening opposite the base wherein the interior chamber is configured to receive an connector, a plurality of flexible fingers extending from the top of the wall. The connector is shaped to be received within the interior chamber of the socket.

### PRIORITY

This application claims priority to U.S. Provisional Patent No. 62/811,089 filed on Feb. 27, 2019, the entire contents of which are hereby incorporated by reference.

### FIELD OF INVENTION

The present invention is directed to a connection system for connecting a handle to a cleaning element, such as reusable or replaceable cleaning accessories.

### BACKGROUND OF INVENTION

Household cleaning devices may comprise a handle attached to a cleaning accessory such as a cleaning pad or brush. Conventional cleaning devices with reusable or replaceable cleaning accessories usually have a single means of attachment to a handle. The attachment does not allow for versatility in range of motion between the handle and the cleaning accessory, which limits the usage of the cleaning accessories. Further, some reusable or replaceable cleaning accessories are only compatible with one type of handle.

### SUMMARY OF INVENTION

An object of the present invention is to provide a means for removably connecting a handle to a cleaning accessory that allows the user to choose a range of motion of the cleaning accessories relative to the handle. Thus, a connection system for a cleaning device is provided. The connection system provides means for removably attaching a handle to a cleaning element, such as a reusable or replaceable cleaning accessory. The cleaning accessory may be, for example, a cleaning pad or brush. The connection system between the handle and the cleaning accessory allows for various degrees of movement. For example, some embodiments allow either limited rotation, no rotation, or full rotation of the cleaning accessory relative to the handle.

In some embodiments, the connection system for a cleaning device comprises a handle with a socket. The socket is defined by a base and a wall extending from the circumference of the base, the wall defining an interior chamber with an opening opposite the base. A plurality of flexible fingers extend from the top of the wall of the socket. The interior chamber of the socket is configured to receive a connector.

A cleaning accessory comprises a cleaning element attached to one side of a base and a connector on the opposite side of the base from the cleaning element. The connector is shaped to be received within the interior chamber of the socket. In some embodiments, the interior chamber and the connector are substantially spherical or hemispherical. The connector is received in the socket and held in place by the flexible fingers. The cleaning accessory may be removed from the socket by applying sufficient force to cause the flexible fingers to deflect and release the connector.

In some embodiments, the cleaning accessory may rotate about the central axis of the handle and may be capable of movement relative to a plane perpendicular to the central axis of the handle.

In some embodiments, the plurality of flexible fingers define at least one lock slot configured to engage at least one lock element on the connector. The lock slot and lock element may prevent movement of the cleaning element relative to the handle.

In some embodiments, the socket further comprises a central pin sized to be received within a corresponding opening in the connector on the base. The central pin allows the cleaning element to rotate relative to the axis of the handle, while maintain the base of the cleaning element in the plane perpendicular to the central axis of the handle.

In some embodiments, the socket has a plurality of lock slots configured to receive a corresponding plurality of lock elements located on the connector. In some embodiments, the socket further comprises a central pin located within the interior chamber of the socket. In some embodiments, the socket is removably attachable to a connector which has a plurality of lock elements.

Other objects, features, and/or advantages will become apparent in view of the following detailed description of the embodiments and the accompanying drawings.

While various objects, features and/or advantages have been described in this summary and/or will become more readily apparent in view of the following detailed description and accompanying drawings, it should be understood that such objects, features and/or advantages are not required in all aspects and embodiments.

This summary is not exhaustive of the scope of the present aspects and embodiments. Thus, while certain aspects and embodiments have been presented and/or outlined in this Summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow.

It should also be understood that any aspects and embodiments that are described in this summary and do not appear in the claims that follow are preserved for later presentation in this application or in one or more continuation patent applications.

### BRIEF DESCRIPTION OF DRAWINGS

FIG. 1 is a perspective view of one embodiment of a connection system in accordance with the present invention;

FIG. 2 is an exploded perspective view of the connection system of FIG. 1;

FIG. 3 is a top view of a connector on the base of a cleaning accessory of one embodiment of a connection system;

FIG. 4A is a bottom view of one embodiment of a socket of a connection system;

FIG. 4B is a perspective view of the socket of FIG. 4A;

FIG. 5 is an exploded perspective view of the connection system of FIG. 1;

FIG. 6 is a perspective view of another embodiment of a connection system in accordance with the present invention;

FIG. 7 is an exploded perspective view of the connection system of FIG. 6;

FIG. 8A is a bottom view of one embodiment of a socket of a connection system;

FIG. 8B is a perspective view of the socket of FIG. 8A;

FIG. 9 is a top view of a connector on the base of a cleaning accessory of one embodiment of a connection system;

FIG. 10 is an exploded perspective view of the connection system of FIG. 6;FIG. 11A is top view of a connector on the base of a cleaning accessory of one embodiment of a connection system;

FIG. 11B is a perspective view of the connector of FIG. 11A;

FIG. 12A is a top view of a connector on the base of a cleaning accessory of one embodiment of a connection system;

FIG. 12B is a perspective view of the connector of FIG. 12A.

FIG. 13 is a perspective view of a socket on a handle of one embodiment of a connection system.

### DETAILED DESCRIPTION

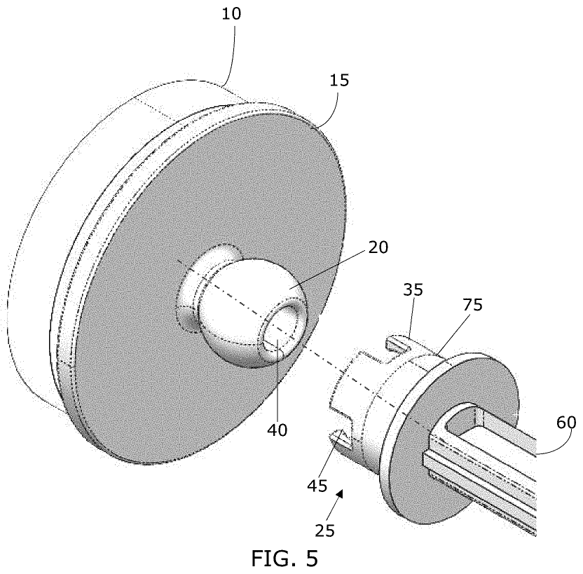

The present invention, for example as seen in FIG. 5, is a connection system for removably connecting a cleaning element 10 to a handle 60. The connection system has a socket 25 attached to the handle 60 and a connector 20 attached to the base 15 of the cleaning element 10.

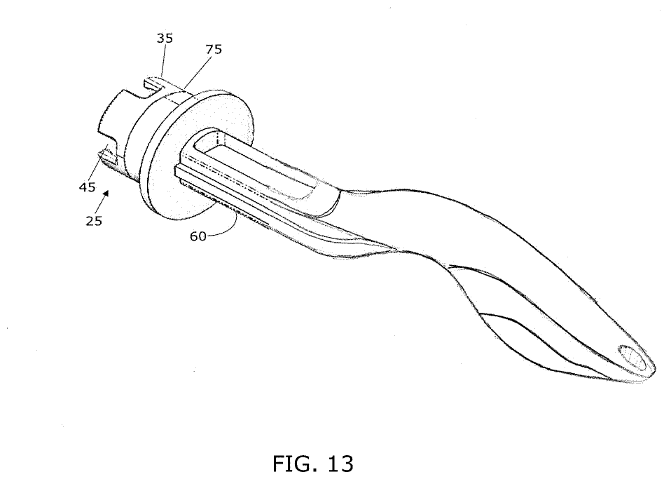

It should be understood by those of ordinary skill in the art that “cleaning element” may refer to any number of cleaning accessories, including, but not limited to, brushes, sponges, brooms, pads, and mops. Similarly, it should be understood that “handle” refers to any type of handle that may be used with such a cleaning element. For example, one embodiment of a handle 60 is illustrated in FIG. 13.

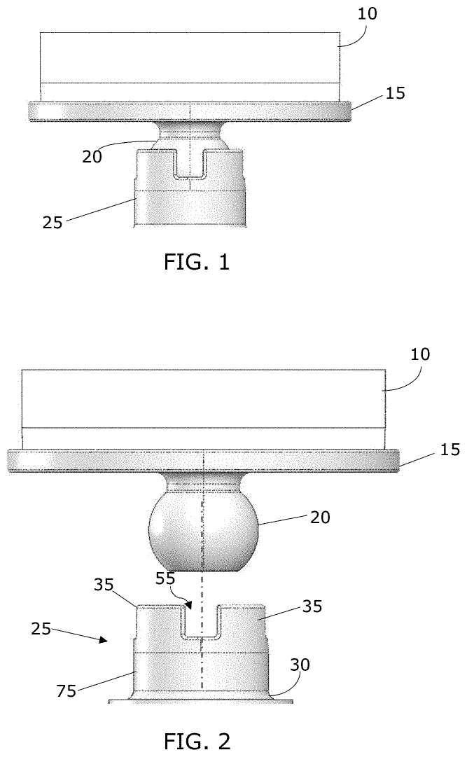

FIGS. 1-5 show one embodiment of a connection system of the present invention. As shown in FIGS. 1-2, a cleaning accessory comprises a cleaning element 10 fixedly attached to one side of a base 15. A connector 20 is fixed to the base 15 on the opposing side from the cleaning element 10. The connector and base may be formed as a single piece, or the connector may be attached to the base by glue or other attachment means. The connector may be spherical or hemispherical in shape.

A socket 25 at the distal end of a handle 60 has an opening having a shape corresponding to the shape of the connector 20. The socket has a plurality of flexible fingers 35 that allow the connector 20 to be received within the corresponding opening in the socket 25. The flexible fingers 35 allow the connector 20 to be removed from the socket when sufficient force is applied to cause the flexible fingers to deflect and release the connector 20 from the socket 25.

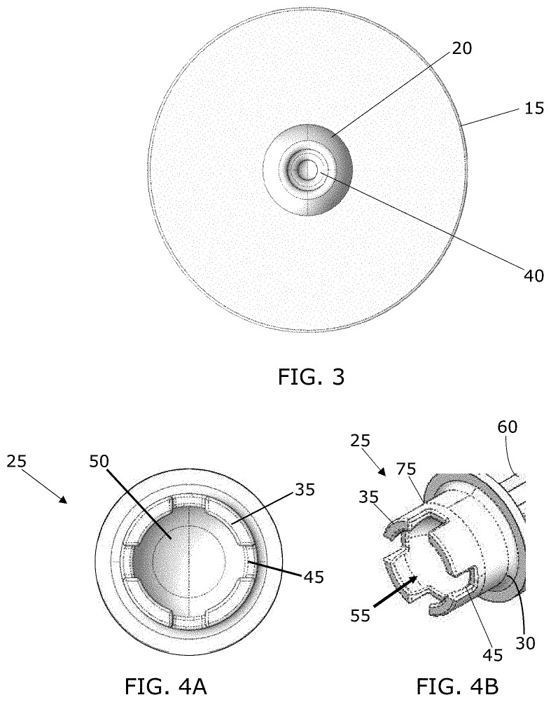

FIG. 3 is a top view of one embodiment of a base 15 for a cleaning element. The base 15 comprises a plate having a connector 20 extending upwardly from the base 15. In the embodiment shown in FIG. 3, the connector 20 may include an opening 40 that may receive a pin in a socket as described further below.

FIGS. 4A and FIG. 4B illustrate a socket 25 attached to a handle 60 wherein the socket 25 comprises a base 30 with a circular wall 75 extending from the circumference of the base 30. The circular wall 75 has an opening 55 opposite the base 30. The circular wall 75 defines an interior chamber 50 configured to receive the connector 20. The socket 25 has a plurality of flexible fingers 35 which extend from the top of the wall 75. In the embodiment shown in FIGS. 1-5, the cleaning accessory is free to rotate relative to the axis of the handle. The cleaning accessory may also move relative to a plane perpendicular to the axis of the handle. In some embodiments, the space between the fingers 35 define a plurality of lock slots 45 which are configured to receive a corresponding plurality of lock elements on the connector as described further below.

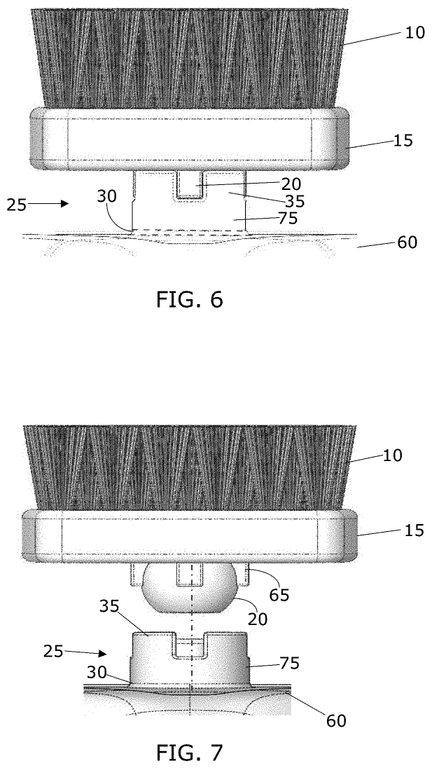

FIGS. 6 and 7 illustrate another embodiment of the present invention wherein the cleaning element 10 is removably attached to the handle 60 via the socket 25 and connector 20 of the connection system. FIG. 7 further shows the embodiment of FIG. 6 wherein the connector 20 is removed from the socket 25. In this embodiment, the connector 20 has lock elements 65 which are sized to fit within the lock slots 45 in the socket 25. The lock elements 65 prevent the cleaning accessory from rotating relative to the axis of the handle.

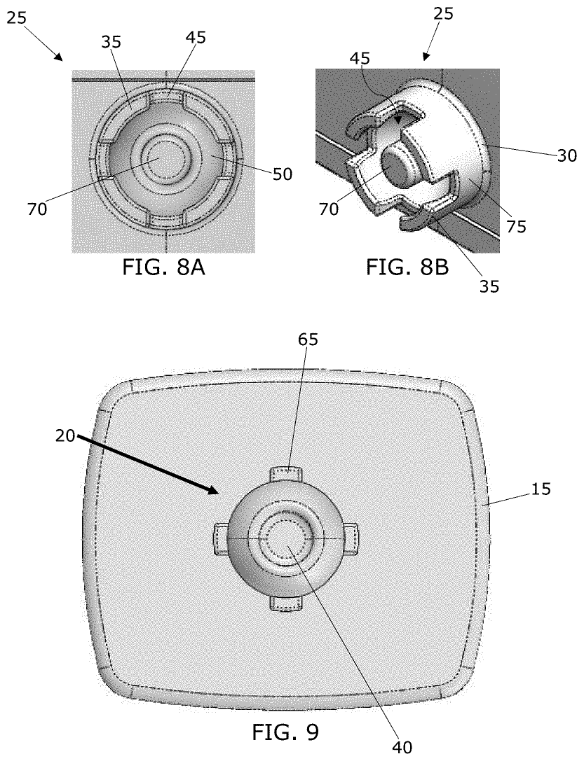

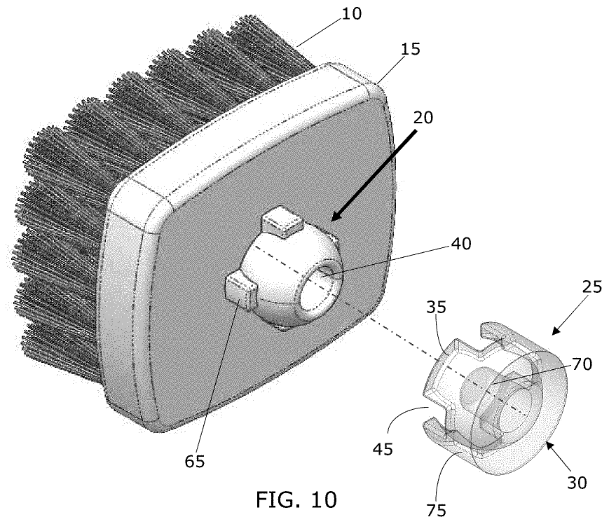

FIGS. 8A and 8B show an embodiment of the socket which includes a central pin 70 located within the socket 25. In this embodiment, when the connector on the base does not include lock elements, the central pin 70 allows rotation of the cleaning accessory relative to the axis of the central pin 70, while maintaining the base of the cleaning accessory in a plane substantially perpendicular to the central axis of the handle. FIG. 9 is a top view of one embodiment of a base 15 for a cleaning element. The base 15 comprises a plate having a connector 20 extending upwardly from the base 15. In the embodiment shown in FIG. 9, the connector 20 may include an opening 40 that may receive the pin in a socket.

As illustrated in FIGS. 7, 9 and 10, the connector 20 may further include a plurality of lock elements 65 which correspond to lock slots 45 located on the socket 25. The lock elements 65 prevent the cleaning accessory from rotating in relation to the handle. FIG. 10 shows a cleaning element 10 with a base 15 and connector 20 having a plurality of lock elements 65 and an opening 40 which corresponds to the central pin 70 on the socket 25. The socket 25 has a base 30 with a wall 75 extending from the circumference of the base 30. At the end of the wall 75 are a plurality of flexible fingers 35 and a plurality of lock slots 45 which correspond to the plurality of lock elements 65 of the connector 20.

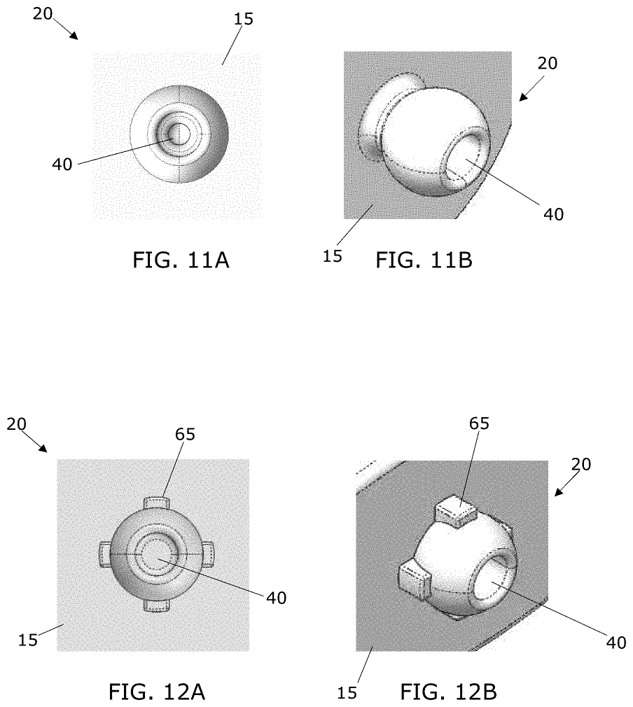

FIG. 11A and FIG. 11B show a connector 20 that has an opening 40 to correspond with a central pin 70 on a socket. The connector shown in FIGS. 11A and 11B do not include lock elements. FIG. 12A and FIG. 12B show a connector 20 that has an opening 40 to correspond with a central pin 70 on a socket and a plurality of lock elements 64 which correspond with a plurality of lock slots 45 on a socket.

In some embodiments, as illustrated in FIG. 11B and FIG. 12B, the connector 20 is substantially hemispherical or spherical. In some such embodiments, the corresponding interior chamber 50 of the socket 25 is also substantially hemispherical or spherical, as illustrated in FIG. 4A and FIG. 8A.

While the above describes certain embodiments, those skilled in the art should understand that the foregoing description is not intended to limit the spirit or scope of the invention. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

We claim:

1. A connection system for removably attaching a cleaning accessory to a handle, comprising:
a handle having a socket defined by a base and a wall extending from the circumference of the base, the wall defining an interior chamber with an opening opposite the base wherein the interior chamber is configured to receive an connector;
a plurality of flexible fingers extending from the top of the wall;
a cleaning element having a base and a connector attached to the base, the connector being shaped to be received within the interior chamber of the socket.

2. The connection system of claim 1, wherein the flexible fingers define at least one lock slot configured to engage at least one lock element on the connector.

3. The connection system of claim 1, wherein the socket further comprises a central pin sized to be received within a corresponding opening in the connector.

4. The connection system of claim 1, wherein the interior chamber and the connector are substantially hemispherical.

5. The connection system of claim 3, wherein the flexible fingers define at least one lock slot configured to engage at least one lock element on the connector.

6. The system of claim 5, wherein the interior chamber and the connector are substantially hemispherical.

7. The connection system of claim 1, wherein the interior chamber of the socket and the connector are substantially spherical.

8. The connection system of claim 2, wherein the interior chamber and connector are substantially hemispherical.
